(19) United States
(12) Patent Application Publication
(10) Pub. No.: US 2025/0354508 A1
(43) Pub. Date: Nov. 20, 2025

(54) MOTORCYCLE-TYPE VEHICLE, IN PARTICULAR MOTORCYCLE, WITH A PARTICULATE FILTER

(71) Applicants: BAYERISCHE MOTOREN WERKE AKTIENGESELLSCHAFT, München (DE); TENNECO GMBH, Edenkoben (DE)

(72) Inventors: Uli BLÜMELHUBER, München (DE); Michael FISCHER, Mainz (DE)

(21) Appl. No.: 18/876,041

(22) PCT Filed: Jul. 18, 2023
(86) PCT No.: PCT/EP2023/069856

§ 371 Date: Dec. 17, 2024

(30) Foreign Application Priority Data
Jul. 18, 2022 (DE) 10 2022 117 886.2

(51) Int. Cl. F01N 3/035; B62K 11/04

(52) U.S. Cl. CPC F01N 3/035; B62K 11/04

(57) ABSTRACT

The invention relates to a motorcycle-type vehicle comprising at least one front wheel, at least one rear wheel, an internal combustion engine with which the motorcycle-type vehicle can be driven, and an exhaust tract through which exhaust gas from the internal combustion engine can flow, and in which a particulate filter is arranged, wherein at least part of the particulate filter is arranged between the internal combustion engine and the rear wheel when viewed in the longitudinal direction of the vehicle.

The invention relates to a motorcycle-type vehicle, in particular a motorcycle, according to the preamble of claim 1.

DE 20 2016 004 869 U1 describes a motorcycle as known, with an engine and with an electronic sound generation system, which comprises at least one loudspeaker for influencing and/or supporting an engine and/or external noise sound.

The object of the present invention is to create a motorcycle-type vehicle, in particular a motorcycle, such that a particularly low-emission operation and at the same time, particularly advantageous aerodynamics of the motorcycle-type vehicle can be realized.

According to the invention, this task is solved by a motorcycle-type vehicle with the features of claim 1. Advantageous embodiments of the invention are the subject of the dependent claims.

The invention relates to a motorcycle-type vehicle. The motorcycle-type vehicle is preferably designed as a motorcycle. The motorcycle-type vehicle, also known as a vehicle, is understood to mean, for example, a single-track motor vehicle, in particular a single-track motorcycle, with exactly two vehicle wheels, also known simply as wheels, arranged one behind the other in the longitudinal direction of the motorcycle-type vehicle. The motorcycle-type vehicle according to the invention can also be understood as a motorcycle-type vehicle, in particular a motorcycle, with a sidecar and thus with exactly three vehicle wheels, also simply referred to as wheels. It is therefore conceivable that the motorcycle-type vehicle has exactly three vehicle wheels. The respective vehicle wheel is a ground contact element via which the motorcycle-type vehicle can be supported or braced against the ground in the vertical direction of the motorcycle-type vehicle. If the motorcycle-type vehicle is driven along the ground while the motorcycle-type vehicle is supported on the ground via the ground contact elements in the vertical direction of the motorcycle-type vehicle, the vehicle wheels roll, in particular directly, on the ground. One of the vehicle wheels of the motorcycle-type vehicle is a rear wheel, and another of the vehicle wheels is a front wheel of the motorcycle-type vehicle, wherein the rear wheel is arranged behind the front wheel in the longitudinal direction of the motorcycle-type vehicle. For example, if the motorcycle-type vehicle has exactly two vehicle wheels, one of the exactly two vehicle wheels is the said front wheel, and the other of the exactly two vehicle wheels is the said rear wheel. If, for example, the motorcycle-type vehicle has exactly three vehicle wheels, it is conceivable that exactly one of the three vehicle wheels is a front wheel and exactly two of the three vehicle wheels are rear wheels, which are arranged behind the exactly one front wheel in the longitudinal direction of the vehicle. Thus, for example, the motorcycle-type vehicle is a two-track tricycle, in particular a trike. If, for example, the motorcycle-type vehicle has exactly three vehicle wheels, it is also conceivable that exactly one of the three vehicle wheels is a rear wheel and exactly two of the three vehicle wheels are front wheels, which are arranged in front of exactly one rear wheel in the longitudinal direction of the vehicle. Thus, for example, the motorcycle-type vehicle is a two-track tricycle in particular. The motorcycle-type vehicle has an internal combustion engine, also known as an internal combustion engine or motor, by means of which the motorcycle-type vehicle can be driven. For example, the internal combustion engine can drive at least or exactly one of the vehicle wheels, in particular the rear wheel, wherein the motorcycle-type vehicle can be driven and thus driven along the ground. It is also conceivable that the internal combustion engine can drive exactly two of the vehicle wheels, in particular the two rear wheels. The motorcycle-type vehicle also has an exhaust tract, also known as an exhaust system, through which exhaust gas from the internal combustion engine can flow. A particulate filter through which the exhaust gas can flow is arranged in the exhaust tract, by means of which any particles contained in the exhaust gas can be filtered out of the exhaust gas. In particular, the internal combustion engine is designed as a gasoline engine, such that the particulate filter can be designed as a gasoline particulate filter (GPF). By using the particulate filter, particularly low-emission operation of the motorcycle-type vehicle can be achieved, as any particles contained in the exhaust gas, in particular soot particles, can be filtered out of the exhaust gas by means of the particulate filter.

Furthermore, in order to be able to realize particularly advantageous aerodynamics and, as a result, particularly efficient operation of the motorcycle-type vehicle, it is provided according to the invention that the particulate filter is arranged at least partially, in particular at least predominantly and thus at least more than half or completely, between the internal combustion engine and the rear wheel when viewed in the longitudinal direction of the motorcycle-type vehicle. This includes the following in particular: The internal combustion engine has an engine block by which at least one or more combustion chambers of the internal combustion engine are at least partially, in particular directly, bounded. For example, the internal combustion engine is designed as a reciprocating piston engine, such that the engine block is preferably a cylinder block. The cylinder block has at least one or more cylinders, wherein the respective cylinder bounds at least partially, in particular directly, the respective combustion chamber. For example, the internal combustion engine has at least one cylinder head, which is separate from the engine block and is connected to the engine block. For example, the cylinder head forms a combustion chamber roof for at least one of the combustion chambers, through which the at least one combustion chamber is partially, in particular directly, bounded. Viewed in the longitudinal direction of the vehicle, the particulate filter is arranged at least partially, in particular at least predominantly and thus at least more than half or completely, between the engine block and the rear wheel, such that the particulate filter adjoins the internal combustion engine, in particular the engine block, towards the rear in the longitudinal direction of the vehicle, and such that the rear wheel adjoins the particulate filter towards the rear in the longitudinal direction of the vehicle. In particular, it is intended that the entire engine block, especially the entire internal combustion engine, is connected to the particulate filter at the front in the longitudinal direction of the vehicle. It is also conceivable that the entire rear wheel is connected to the particulate filter towards the rear in the longitudinal direction of the vehicle. In particular, the invention is based on the realization that, on the one hand, the use of the particulate filter enables particularly low-emission operation of the motorcycle-type vehicle. On the other hand, positioning the particulate filter in or on the motorcycle-type vehicle is problematic, as the particulate filter has a large volume and therefore requires a lot of installation space, particularly due to the way it works. It is desirable to arrange the particulate filter in such a way that the motorcycle-type vehicle equipped with the particulate filter has particularly good aerodynamics and can therefore be driven particularly efficiently and thus with low fuel consumption. It was found that the arrangement of the particulate filter between the internal combustion engine, in particular the engine block, and the rear wheel, viewed in the longitudinal direction of the vehicle, makes it possible to achieve particularly advantageous aerodynamics for the motorcycle-type vehicle.

In order to be able to realize particularly advantageous aerodynamics of the motorcycle-type vehicle, it is provided in one embodiment of the invention that the particulate filter is arranged between the internal combustion engine, in particular the engine block, and the rear wheel at least partially, in particular at least predominantly and thus at least more than half or completely, when viewed in the longitudinal direction of the vehicle, that the particulate filter is at least partially, in particular at least predominantly and thus at least more than half or completely, overlapped by the internal combustion engine, in particular by the engine block, in the longitudinal direction of the vehicle towards the front and at least partially, in particular at least predominantly and thus at least more than half or completely, overlapped by the rear wheel in the longitudinal direction of the vehicle towards the rear.

In a further embodiment of the invention, the motorcycle-type vehicle has a frame on which a rear wheel swing arm is pivotably mounted and thus held, in particular in such a way that the rear wheel swing arm, also known simply as the swing arm or rear wheel fork, can be pivoted relative to the frame about a pivot axis extending in the transverse direction of the motorcycle-type vehicle. For example, a seat is attached to the frame on which a person such as the rider of the motorcycle-type vehicle can sit. The rear wheel is held on the rear wheel swing arm such that it can rotate relative to the rear wheel swing arm, in particular about a rear wheel pivot axis. If the motorcycle-type vehicle is ridden along the ground while the motorcycle-type vehicle is supported on the ground via the ground contact elements in the vertical direction of the motorcycle-type vehicle, the rear wheel rotates about the rear wheel pivot axis relative to the rear wheel swing arm and relative to the frame.

In order to be able to realize particularly advantageous aerodynamics of the motorcycle-type vehicle, it is provided in a further embodiment of the invention that at least a partial area of the particulate filter is arranged lower than at least a partial area of the rear wheel swing arm when viewed in the vertical direction of the vehicle. In other words, it is preferable for the particulate filter to be arranged at least partially, in particular at least predominantly and thus at least more than half or completely, below the rear wheel swing arm in the vertical direction of the vehicle. This prevents excessive air resistance of the motorcycle-type vehicle. In addition, a particularly advantageous, especially neutral, weight distribution of the motorcycle-type vehicle can be realized, especially when viewed in the longitudinal direction of the vehicle. In addition, a particularly advantageous weight distribution in the transverse direction of the motorcycle-type vehicle can be realized, such that particularly advantageous driving characteristics or a particularly advantageous driving behavior of the motorcycle-type vehicle can be represented. The arrangement of the particulate filter according to the invention, viewed in the longitudinal direction of the vehicle between the internal combustion engine and the rear wheel, also makes it possible to realize an advantageously short response time of the particulate filter, such that, for example, the particulate filter can filter out any particles contained in the exhaust gas from the exhaust gas particularly advantageously a short time after a start, in particular after a cold start, of the internal combustion engine. This means that the motorcycle-type vehicle can be operated with particularly low emissions.

In an advantageous embodiment of the invention, the motorcycle-type vehicle has a transmission via which the motorcycle-type vehicle, in particular the rear wheel, can be driven by the internal combustion engine. For example, the transmission has several, in particular shiftable, gears, in particular with different ratios, via which the motorcycle-type vehicle, in particular the rear wheel, can be driven by the internal combustion engine. For example, the internal combustion engine has an output shaft via which the internal combustion engine can provide torque to drive the motorcycle-type vehicle. In particular, if the internal combustion engine is designed as a reciprocating piston engine, the output shaft is designed as a crankshaft. For example, the output shaft is connected or can be connected to a transmission input shaft of the transmission in a torque-transmitting manner, in particular in a torsionally rigid manner, such that the respective torque that is provided or can be provided by the internal combustion engine via the output shaft can be transmitted from the output shaft to the transmission input shaft and can thus be introduced into the transmission. The respective torque can be transferred to the rear wheel via the transmission, for example, in order to drive the rear wheel and thus the motorcycle-type vehicle.

It has been shown to be particularly advantageous if the particulate filter is arranged at least partially between the transmission and the rear wheel and thus between the internal combustion engine and the rear wheel when viewed in the longitudinal direction of the vehicle, whereby particularly advantageous aerodynamics and thus particularly efficient operation of the motorcycle-type vehicle can be realized.

A further embodiment is characterized in that the particulate filter, viewed in the longitudinal direction of the vehicle, is arranged at least partially, in particular at least predominantly and thus at least more than half or completely, between the transmission and the rear wheel in such a way that the particulate filter is arranged at least partially, in particular at least predominantly and thus at least more than half or completely, towards the front in the longitudinal direction of the vehicle, is arranged between the transmission and the rear wheel in such a way that the particulate filter is at least partially, in particular at least predominantly and thus at least more than half or completely, overlapped by the transmission towards the front in the longitudinal direction of the vehicle and at least partially, in particular at least predominantly and thus at least more than half or completely, overlapped by the rear wheel towards the rear in the longitudinal direction of the vehicle. This can, for example, prevent the particulate filter from being subjected to excessive airflow when the motorcycle-type vehicle is moving forwards, which can keep the air resistance of the motor vehicle particularly low.

In one embodiment of the invention, a muffler is arranged in the exhaust tract in order to achieve particularly quiet operation of the motorcycle-type vehicle. In order to achieve a particularly short response time of the particulate filter and particularly advantageous aerodynamics of the motorcycle-type vehicle, it can be provided that the particulate filter is arranged in the muffler or upstream of the muffler. In particular, this allows the particulate filter to be positioned with a particularly favorable center of gravity. In other words, this allows the particulate filter to be positioned advantageously low when viewed in the vertical direction of the vehicle, whereby a particularly low position of the motorcycle-type vehicle's center of gravity can be achieved when viewed in the vertical direction of the vehicle.

It is also conceivable that the particulate filter can at least partially assume or support an acoustic function of the muffler, also known as the exhaust muffler, which can keep the weight of the motorcycle-type vehicle particularly low. This ensures particularly efficient operation.

In order to keep the weight, costs and installation space requirements of the exhaust tract particularly low and consequently to be able to realize particularly efficient operation of the motorcycle-type vehicle, it is provided in a further embodiment of the invention that the particulate filter has a catalytic coating. For example, the catalytic coating is designed as a three-way catalyst, i.e. catalytically active like a three-way catalyst, such that, for example, the catalytic coating is designed like a three-way catalyst to catalytically support or cause a chemical reaction of any carbon monoxide contained in the exhaust gas with oxygen to form carbon dioxide, a chemical reaction of unburned hydrocarbon with oxygen to form carbon dioxide and water and a chemical reaction of nitrogen monoxide with carbon monoxide to form nitrogen and carbon dioxide. This makes it possible, for example, to dispense with a separate, additional three-way catalyst in the exhaust tract, or the volume, weight and costs of such an additional three-way catalyst can be kept to a minimum.

In a further, particularly advantageous embodiment of the invention, the exhaust tract has at least two exhaust gas flows through which respective parts of the exhaust gas of the internal combustion engine can flow and which are separated from one another upstream of the particulate filter, at least in respective partial areas, which are also simply referred to as flows. The particulate filter is a particulate filter that is common to the exhaust gas flows and through which the parts of the exhaust gas flowing through the exhaust gas flows can flow. This means that the use of individual particulate filters per exhaust gas flow can be avoided, such that the costs, weight and installation space requirements of the exhaust tract can be kept particularly low. This enables particularly efficient operation of the motorcycle-type vehicle.

Finally, it has been shown to be particularly advantageous if the particulate filter has exactly one inlet or several separate inlets via which the exhaust gas can be fed into the particulate filter. In other words, the particulate filter can be supplied with a single or multiple flow of exhaust gas, for example through a manifold system, such that the particulate filter can be supplied with the exhaust gas in a particularly flow-optimized and therefore low-loss manner.

Further details of the invention can be found in the following description of preferred exemplary embodiments with the associated drawings. It shows:

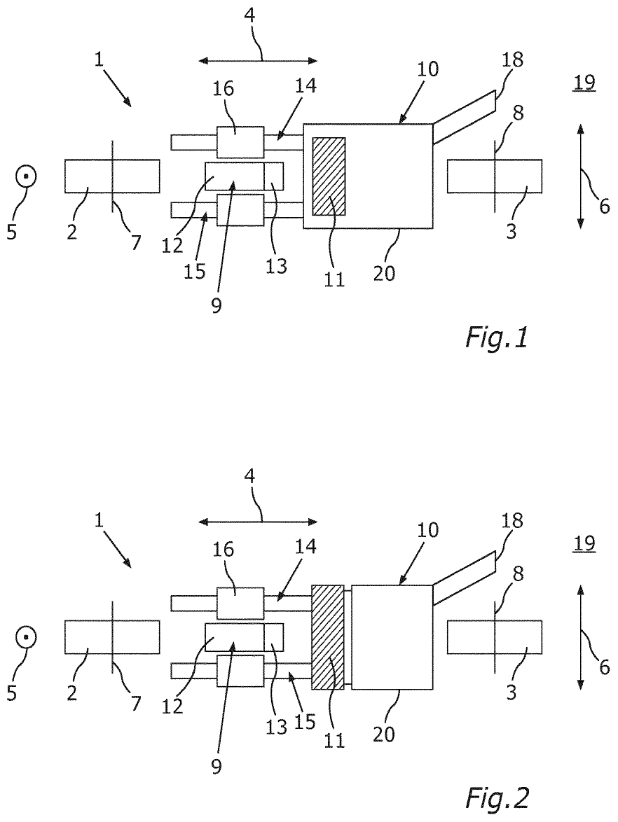

FIG. 1 a schematic top view of a first embodiment of a motorcycle-type vehicle; and

FIG. 2 a schematic top view of a second embodiment of the motorcycle-type vehicle.

In the figures, identical or functionally identical elements are marked with the same reference symbols.

FIG. 1 shows a schematic top view of a first embodiment of a motorcycle-type vehicle 1 designed as a motorcycle, which in the first embodiment is designed as a single-track motor vehicle with exactly two vehicle wheels 2 and 3. FIG. 1 shows that the vehicle wheels 2 and 3 are arranged one behind the other in the longitudinal direction of the motorcycle-type vehicle 1, also known as the vehicle, wherein the longitudinal direction of the vehicle is illustrated in FIG. 1 by a double arrow 4. The vehicle wheel 2 is a front wheel, wherein the vehicle wheel 3 is a rear wheel of the motorcycle-type vehicle 1. The motorcycle-type vehicle 1 has a frame that is not visible in FIG. 1, on which, for example, at least one seat for the rider of the motorcycle-type vehicle 1, which is also not visible in FIG. 1, is held. For example, a front wheel fork not shown in FIG. 1 is pivotably mounted on the frame such that the front wheel fork can be pivoted about a steering axis relative to the frame. For example, the steering axle runs parallel to a plane spanned by the longitudinal direction and the vertical direction of the motorcycle-type vehicle 1, wherein the vertical direction of the vehicle is illustrated by a double arrow 5 and runs perpendicular to the longitudinal direction of the vehicle. For example, the steering axis runs at an angle or perpendicular to a second plane spanned by the longitudinal direction and the transverse direction of the motorcycle-type vehicle 1, wherein the transverse direction of the vehicle is illustrated in FIG. 1 by a double arrow 6. The vehicle wheel 2 is held on the front wheel fork such that it can rotate about a first wheel pivot axis 7 relative to the front wheel fork and can therefore rotate about the wheel pivot axis 7 relative to the front wheel fork and relative to the frame. This means that the vehicle wheel 2 and the wheel pivot axis 7 can also be pivoted with the front wheel fork about the steering axis relative to the frame and can therefore also be steered. If the front wheel fork and thus the vehicle wheel 2 are pivoted relative to the frame about the steering axis, in particular while the motorcycle-type vehicle 1 is being driven along the ground and in particular while the motorcycle-type vehicle 1 is supported on the ground via its vehicle wheels 2 and 3, which are also known as ground contact elements or are designed as ground contact elements, in the vertical direction of the vehicle, cornering, changes of direction and lane changes of the motorcycle-type vehicle 1 can be effected, and thus the motorcycle-type vehicle 1 can be steered.

The motorcycle-type vehicle 1 also has a rear wheel swing arm, not shown in FIG. 1, which is pivotably held on the frame, in particular in such a way that the rear wheel swing arm can be pivoted relative to the frame about a pivot axis running in the transverse direction of the vehicle. The vehicle wheel 3 is held on the rear wheel swing arm such that it can rotate about a second wheel pivot axis 8 relative to the rear wheel swing arm, such that the wheel pivot axis 8 and the vehicle wheel 3 can also pivot with the rear wheel swing arm about the pivot axis relative to the frame. During said travel of the motorcycle-type vehicle 1 along the ground, the vehicle wheels 2 and 3 roll directly on the ground, and the vehicle wheel 2 rotates about the wheel pivot axis 7 relative to the frame, the rear wheel swing arm and the front wheel fork, and the vehicle wheel 3 rotates about the wheel pivot axis 8 relative to the rear wheel swing arm and relative to the frame and relative to the front wheel fork. For example, a steering handle, in particular designed as a handlebar, is arranged on the front wheel fork, which the rider can grip or grasp such that the rider can use the steering handle to swivel the front wheel fork about the steering axis relative to the frame and thus steer the motorcycle-type vehicle 1.

The motorcycle-type vehicle 1 has an internal combustion engine 9, which is also referred to as an internal combustion engine or motor. The internal combustion engine 9 can be part of the frame, such that, for example, the frame can comprise the internal combustion engine 9 as a first frame part. Furthermore, the frame can, for example, comprise a second frame part that is separate from the internal combustion engine and connected to the internal combustion engine 9. The vehicle wheel 3 (rear wheel) and thus the motorcycle-type vehicle 1 as a whole can be driven by means of the internal combustion engine 9. For this purpose, the internal combustion engine 9 has an output shaft, not shown in FIG. 1, via which the internal combustion engine 9 can provide torque to drive the rear wheel. The internal combustion engine 9 provides exhaust gas, particularly during fired operation of the internal combustion engine 9. The motorcycle-type vehicle 1 has an exhaust tract 10, which is in particular separate from the internal combustion engine 9 and through which the exhaust gas from the internal combustion engine 9 can flow. A particulate filter 11 is arranged in the exhaust tract 10, by means of which particles, in particular particulate matter, can be filtered out of the exhaust gas. In the first embodiment, the internal combustion engine 9 is designed as a gasoline engine, such that the particulate filter 11 is designed as a gasoline particulate filter (GPF).

In order to achieve particularly advantageous aerodynamics and thus particularly efficient operation of the motorcycle-type vehicle 1, the particulate filter 11 is arranged at least partially, in particular at least predominantly and thus at least more than half or completely, between the internal combustion engine 9 and the rear wheel (vehicle wheel 3) when viewed in the longitudinal direction of the vehicle (double arrow 4). In the first embodiment, the internal combustion engine 9 is designed as a reciprocating piston engine, for example. The internal combustion engine 9 has an engine block in the form of a cylinder housing 12, which has several and thus at least or exactly two cylinders or, in particular, directly bounds them. The respective cylinder partially bounds a respective combustion chamber, in which combustion processes take place during the fired operation of the internal combustion engine, resulting in the exhaust gas. The particulate filter 11 is arranged at least partially between the cylinder housing 12 and the rear wheel when viewed in the longitudinal direction of the vehicle, in particular in such a way that the particulate filter 11 is at least partially, in particular at least predominantly and thus at least more than half or completely, overlapped by the cylinder housing 12 in the longitudinal direction of the vehicle towards the front and at least partially overlapped by the rear wheel in the longitudinal direction of the vehicle towards the rear. In order to achieve a particularly advantageous position of the center of gravity of the motorcycle-type vehicle 1, it is also preferable for the particulate filter 11 to be arranged at least partially, in particular at least predominantly and thus at least more than half or completely, lower than at least a partial area of the rear wheel swing arm, in particular than the entire rear wheel swing arm, when viewed in the vertical direction of the vehicle.

For example, the motorcycle-type vehicle 1 has a transmission 13, shown particularly schematically in FIG. 1, via which the rear wheel can be driven by the internal combustion engine 9, in particular by the output shaft. It is preferable for the particulate filter 11 to be arranged at least partially between the transmission 13 and the rear wheel when viewed in the longitudinal direction of the vehicle, in particular in such a way that the particulate filter 11 is at least partially overlapped by the transmission 13 towards the front in the longitudinal direction of the vehicle.

The exhaust tract 10 has at least or exactly two exhaust gas flows 14 and 15 through which respective parts of the exhaust gas can flow and which are at least partially separated from one another upstream of the particulate filter 11 in the direction of flow of the exhaust gas flowing through the exhaust tract 10. This means, for example, that the exhaust gas from a first of the combustion chambers flows through the exhaust gas flow 14 and the exhaust gas from a second of the combustion chambers flows through the exhaust gas flow 15, while, for example, the exhaust gas from the second combustion chamber does not flow through the exhaust gas flow 14 and the exhaust gas from the first combustion chamber does not flow through the exhaust gas flow 15. Thus, the exhaust gas from the first combustion chamber flowing through the exhaust gas flow 14 is a first of the parts of the exhaust gas mentioned, and the exhaust gas from the second combustion chamber flowing through the exhaust gas flow 15 is a second of the parts of the exhaust gas. As can be seen from FIG. 1, the particulate filter 11 is a particulate filter common to the exhaust gas flows 14 and 15, through which both the exhaust gas flowing through the exhaust gas flow 14 and the exhaust gas flowing through the exhaust gas flow 15 can flow.

A first catalyst 16 is arranged in the exhaust gas flow 14 and thus upstream of the particulate filter 11, and a second catalyst 17 is arranged in the exhaust gas flow 15 and thus upstream of the particulate filter 11, wherein the catalysts 16 and 17 are separate, individual components arranged externally with respect to one another. In particular, the respective catalyst 16, 17 is designed as a three-way catalyst. Preferably, the particulate filter 11 has a catalytic coating, which is preferably designed as a three-way catalyst and is therefore catalytically effective like a three-way catalyst. One tailpipe of the exhaust tract 10 is labeled 18 in FIG. 1, wherein the exhaust tract 10 leads to an environment 19 of the motorcycle-type vehicle 1 via the tailpipe 18. It can be seen that the tailpipe 18 is arranged downstream of the particulate filter 11.

A muffler 20 is also arranged in the exhaust tract 10. In the first embodiment, the particulate filter 11 is arranged in the muffler 20, in particular in its housing, in order to achieve a particularly low installation space requirement of the exhaust tract 10 and thus particularly advantageous aerodynamics of the motorcycle-type vehicle 1. This also allows a particularly advantageous position of the center of gravity of the motorcycle-type vehicle 1 to be achieved.

FIG. 2 shows a schematic top view of a second embodiment of the motorcycle-type vehicle 1. The second embodiment differs in particular from the first embodiment in that the particulate filter 11 in the second embodiment is arranged outside the muffler 20 and upstream of the muffler 20. In the second embodiment, the particulate filter 11 is also a common particulate filter for the exhaust gas flows 14 and 15.

### LIST OF REFERENCE SYMBOLS

1 Motorcycle-type vehicle
2 Vehicle wheel
3 Vehicle wheel
4 Double arrow
5 Double arrow
6 Double arrow
7 Wheel pivot axis
8 Wheel pivot axis
9 Internal combustion engine
10 Exhaust tract
11 Particulate filter
12 Cylinder housing
13 Transmission
14 Exhaust gas flow
15 Exhaust gas flow
16 Catalyst
17 Catalyst
18 Tailpipe
19 Environment
20 Muffler

1. A motorcycle-type vehicle comprising:
at least one front wheel, at least one rear wheel, an internal combustion engine by which the motorcycle-type vehicle can be driven, and an exhaust tract through which exhaust gas from the internal combustion engine can flow, in which a particulate filter is arranged,
wherein:
the particulate filter is arranged at least partially between the internal combustion engine and a rear wheel when viewed in a longitudinal direction of the vehicle.

2. The motorcycle-type vehicle according to claim 1,
wherein:
the particulate filter is arranged at least partially between the internal combustion engine and the rear wheel, viewed in the longitudinal direction of the vehicle, in such a way that the particulate filter is at least partially overlapped by the internal combustion engine towards the front in the longitudinal direction of the vehicle and at least partially overlapped by the rear wheel towards the rear in the longitudinal direction of the vehicle.

3. The motorcycle-type vehicle according to claim 1,
further comprising:
a frame on which a rear wheel swing arm is pivotably mounted, on which the rear wheel is rotatably held.

4. The motorcycle-type vehicle according to claim 3,
wherein:
at least a partial area of the particulate filter is arranged lower than at least a partial area of the rear wheel swing arm when viewed in a vertical direction of the vehicle.

5. The motorcycle-type vehicle according to claim 1,
further comprising:
a transmission via which the motorcycle-type vehicle can be driven by the internal combustion engine, wherein the particulate filter is arranged at least partially between the transmission and the rear wheel when viewed in the longitudinal direction of the vehicle.

6. The motorcycle-type vehicle according to claim 5,
wherein:
the particulate filter is arranged at least partially between the transmission and the rear wheel as viewed in the longitudinal direction of the vehicle in such a way that the particulate filter is at least partially overlapped by the transmission towards the front in the longitudinal direction of the vehicle and at least partially overlapped by the rear wheel towards the rear in the longitudinal direction of the vehicle.

7. The motorcycle-type vehicle according to claim 1,
wherein:
a muffler is arranged in the exhaust tract, wherein the particulate filter is arranged in the muffler or upstream of the muffler.

8. The motorcycle-type vehicle according to claim 1,
wherein:
the particulate filter has a catalytic coating.

9. The motorcycle-type vehicle according to claim 1,
wherein:
the exhaust tract has at least two exhaust gas flows through which respective partial areas of the exhaust gas can flow and which are separated from one another at least in respective partial regions upstream of the particulate filter, wherein the particulate filter is a particulate filter which is common to the exhaust gas flows and through which parts of the exhaust gas flowing through the exhaust gas flows can flow.

10. The motorcycle-type vehicle according to claim 1,
wherein:
the particulate filter has precisely one inlet or a plurality of separate inlets via which the exhaust gas can be introduced into the particulate filter.
